(19) United States
(12) Patent Application Publication
(10) Pub. No.: US 2006/0198442 A1
(43) Pub. Date: Sep. 7, 2006

(54) Method, apparatus and system for frame level recovery using a collection of badly received frames

(76) Inventor: Curt Jutzi, Lake Oswego, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/024,539

(22) Filed: Dec. 28, 2004

(51) Int. Cl. H04N 11/02

(52) U.S. Cl. 375/240.16

(57) ABSTRACT

In some embodiments, a method, apparatus and system for frame level recovery using a collection of badly received frames are presented. In this regard, an estimation agent is introduced to store contents from a plurality of badly received frames, and to use the contents to generate an estimate frame for an intended frame. Other embodiments are also disclosed and claimed.

### FIELD OF THE INVENTION

Embodiments of the present invention generally relate to the field of communications, and, more particularly to a method, apparatus and system for frame level recovery using a collection of badly received frames.

### BACKGROUND OF THE INVENTION

In many networks, including wireless networks, a receiver converts analog signals into digital data at a physical layer of a communications stack. This digital data is typically passed up in the stack to a media access control (MAC) layer that verifies whether a group of received data (for example, a frame) matches what was actually intended by the sender by computing and comparing checksum or cyclic redundancy check (CRC) values. When the checksum or CRC computed at the receiver matches the received checksum or CRC computed at the sender, the frame is typically passed up to a higher layer in the communications stack and an acknowledgment of receipt is transmitted. When the checksums or CRC's do not match, the frame is typically discarded. The sender may attempt to resend a frame at a designated interval until it reaches a maximum retry limit or it receives an acknowledgement that the intended frame was received.

### BRIEF DESCRIPTION OF THE DRAWINGS

The present invention is illustrated by way of example and not limitation in the figures of the accompanying drawings in which like references indicate similar elements, and in which:

FIG. 1 is a block diagram of an example electronic appliance suitable for implementing an estimation agent, in accordance with one example embodiment of the invention;

FIG. 2 is a block diagram of an example estimation agent architecture, in accordance with one example embodiment of the invention;

FIG. 3 is a flow chart of an example method for frame level recovery using a collection of badly received frames, in accordance with one example embodiment of the invention; and

FIG. 4 is a block diagram of an example storage medium comprising content which, when accessed by a device, causes the device to implement one or more aspects of one or more embodiment(s) of the invention.

### DETAILED DESCRIPTION

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

FIG. 1 is a block diagram of an example electronic appliance suitable for implementing an estimation agent, in accordance with one example embodiment of the invention. Electronic appliance 100 is intended to represent any of a wide variety of traditional and non-traditional electronic appliances, laptops, desktops, cell phones, wireless communication subscriber units, wireless communication telephony infrastructure elements, personal digital assistants, set-top boxes, or any electric appliance that would benefit from the teachings of the present invention. In accordance with the illustrated example embodiment, electronic appliance 100 may include one or more of processor(s) 102, memory controller 104, system memory 106, input/output controller 108, network controller 110, estimation agent 112, and input/output device(s) 114 coupled as shown in FIG. 1. Estimation agent 112, as described more fully hereinafter, may well be used in electronic appliances of greater or lesser complexity than that depicted in FIG. 1. Also, the innovative attributes of estimation agent 112 as described more fully hereinafter may well be embodied in any combination of hardware and software.

Processor(s) 102 may represent any of a wide variety of control logic including, but not limited to one or more of a microprocessor, a programmable logic device (PLD), programmable logic array (PLA), application specific integrated circuit (ASIC), a microcontroller, and the like, although the present invention is not limited in this respect.

Memory controller 104 may represent any type of chipset or control logic that interfaces system memory 106 with the other components of electronic appliance 100. In one embodiment, the connection between processor(s) 102 and memory controller 104 may be referred to as a front-side bus. In another embodiment, memory controller 104 may be referred to as a north bridge.

System memory 106 may represent any type of memory device(s) used to store data and instructions that may have been or will be used by processor(s) 102. Typically, though the invention is not limited in this respect, system memory 106 will consist of dynamic random access memory (DRAM). In one embodiment, system memory 106 may consist of Rambus DRAM (RDRAM). In another embodiment, system memory 106 may consist of double data rate synchronous DRAM (DDRSDRAM). The present invention, however, is not limited to the examples of memory mentioned here.

Input/output (I/O) controller 108 may represent any type of chipset or control logic that interfaces I/O device(s) 114 with the other components of electronic appliance 100. In one embodiment, I/O controller 108 may be referred to as a south bridge. In another embodiment, I/O controller 108 may comply with the Peripheral Component Interconnect (PCI) Express™ Base Specification, Revision 1.0a, PCI Special Interest Group, released Apr. 15, 2003.

Network controller 110 may represent any type of device that allows electronic appliance 100 to communicate with other electronic appliances or devices. In one embodiment, network controller 110 may comply with a The Institute of Electrical and Electronics Engineers, Inc. (IEEE) 802.11b standard (approved Sep. 16, 1999, supplement to ANSI/IEEE Std 802.11, 1999 Edition). In another embodiment, network controller 110 may be an Ethernet network interface card.

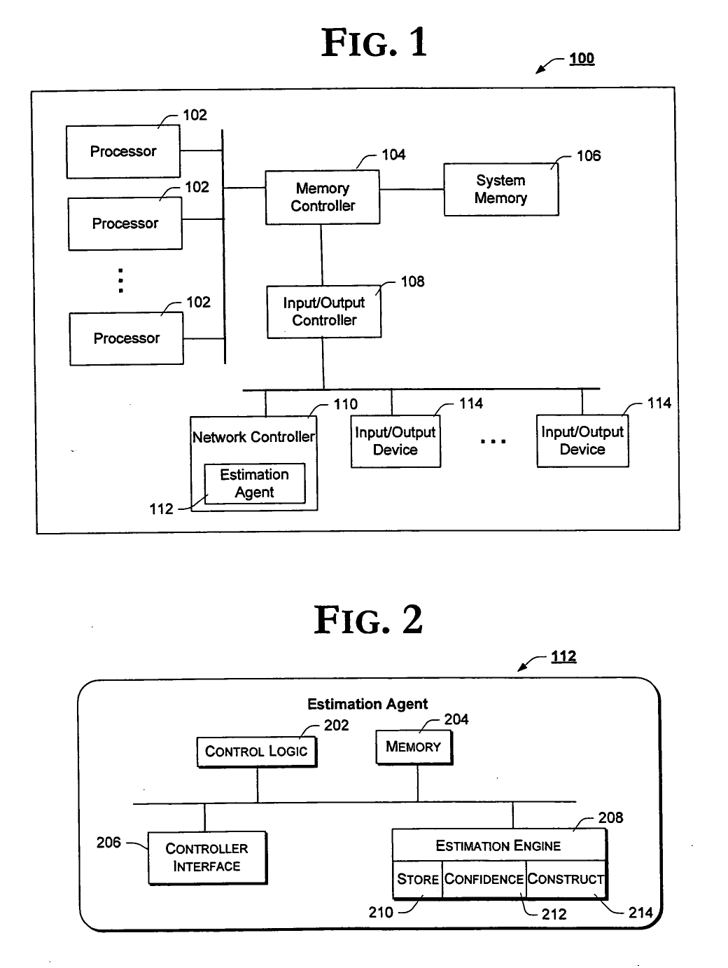

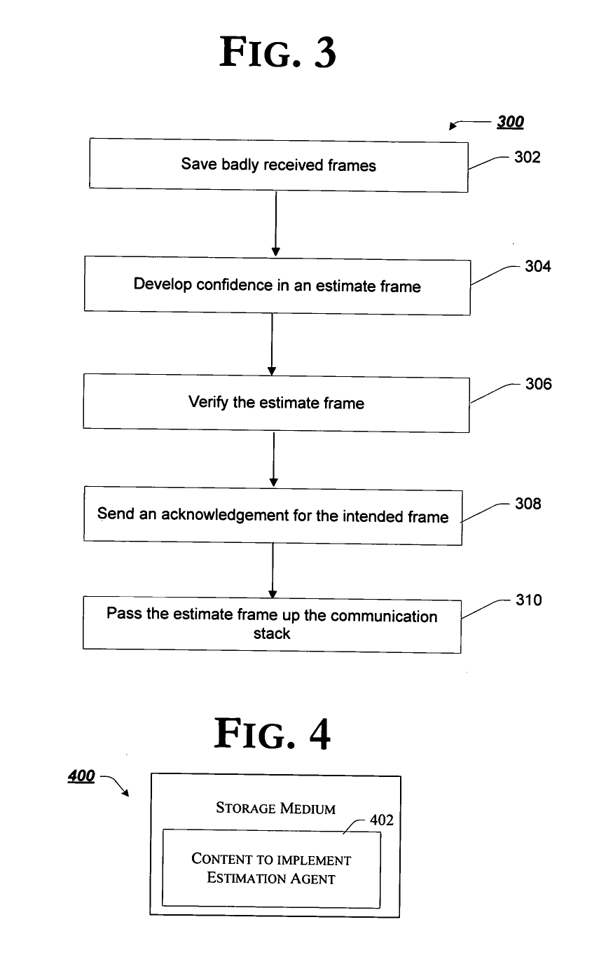

Estimation agent 112 may have an architecture as described in greater detail with reference to FIG. 2. Estimation agent 112 may also perform one or more methods for frame level recovery using a collection of badly received frames, such as the method described in greater detail with reference to FIG. 3. While shown as being part of network controller 110, estimation agent 112 may well be part of another component, for example processor(s) 102 or input/output controller 108, or may be implemented in software or a combination of hardware and software.

Input/output (I/O) device(s) 114 may represent any type of device, peripheral or component that provides input to or processes output from electronic appliance 100.

FIG. 2 is a block diagram of an example estimation agent architecture, in accordance with one example embodiment of the invention. As shown, estimation agent 112 may include one or more of control logic 202, memory 204, controller interface 206, and estimation engine 208 coupled as shown in FIG. 2. In accordance with one aspect of the present invention, to be developed more fully below, estimation agent 112 may include an estimation engine 208 comprising one or more of store services 210, confidence services 212, and/or construct services 214. It is to be appreciated that, although depicted as a number of disparate functional blocks, one or more of elements 202-214 may well be combined into one or more multi-functional blocks. Similarly, estimation engine 208 may well be practiced with fewer functional blocks, i.e., with only confidence services 212, without deviating from the spirit and scope of the present invention, and may well be implemented in hardware, software, firmware, or any combination thereof. In this regard, estimation agent 112 in general, and estimation engine 208 in particular, are merely illustrative of one example implementation of one aspect of the present invention. As used herein, estimation agent 112 may well be embodied in hardware, software, firmware and/or any combination thereof.

Estimation agent 112 may have the ability to store contents from a plurality of badly received frames, and to use the contents to generate an estimate frame for an intended frame. In one embodiment, estimation agent 112 may collect badly received frames until it reaches a threshold confidence level in an estimate frame. In another embodiment, estimation agent 112 may verify the estimate frame with CRC values.

As used herein control logic 202 provides the logical interface between estimation agent 112 and its host electronic appliance 100. In this regard, control logic 202 may manage one or more aspects of estimation agent 112 to provide a communication interface to electronic appliance 100, e.g., through network controller 110.

According to one aspect of the present invention, though the claims are not so limited, control logic 202 may selectively invoke the resource(s) of estimation engine 208. As part of an example method for frame level recovery using a collection of badly received frames, as explained in greater detail with reference to FIG. 3, control logic 202 may selectively invoke store services 210 that may store badly received frames. Control logic 202 also may selectively invoke confidence services 212 or construct services 214, as explained in greater detail with reference to FIG. 3, to develop confidence in an estimate frame or to construct and process an estimate frame, respectively. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. In some implementations, control logic 202 is intended to represent content (e.g., software instructions, etc.), which when executed implements the features of control logic 202 described herein.

Memory 204 is intended to represent any of a wide variety of memory devices and/or systems known in the art. According to one example implementation, though the claims are not so limited, memory 204 may well include volatile and non-volatile memory elements, possibly random access memory (RAM) and/or read only memory (ROM). Memory 204 may be used to store badly received frames, for example.

Controller interface 206 provides a path through which estimation agent 112 can communicate with network controller 110. In one embodiment, controller interface 206 may represent any of a wide variety of interfaces or controllers known in the art. In another embodiment, controller interface 206 may comply with the System Management Bus (SMBus) Specification, Version 2.0, SBS Implementers Forum, released Aug. 3, 2000.

As introduced above, estimation engine 208 may be selectively invoked by control logic 202 to store badly received frames, to develop confidence in an estimate frame, or to construct and process the estimate frame. In accordance with the illustrated example implementation of FIG. 2, estimation engine 208 is depicted comprising one or more of store services 210, confidence services 212 and construct services 214. Although depicted as a number of disparate elements, those skilled in the art will appreciate that one or more elements 210-214 of estimation engine 208 may well be combined without deviating from the scope and spirit of the present invention.

Store services 210, as introduced above, may provide estimation agent 112 with the ability to store badly received frames. In one example embodiment, store services 210 may store the badly received frames in memory 204. A badly received frame could be any frame that can not be verified, for example frames that fail an error check such as a CRC. If the intended frame is subsequently received properly (i.e. passing an error check), store services 210 may clear any badly received copies of that frame. In one embodiment, store services 210 may be able to store such number of badly received attempts at an intended frame as the network protocol's maximum retry limit.

As introduced above, confidence services 212 may provide estimation agent 112 with the ability to develop confidence in an estimate frame. An estimate frame is a calculated guess as to what the intended frame actually sent was. In one example embodiment, confidence services 212 may use the number of badly received frames and the occurrences of one's and zero's in each bit field to determine whether a threshold confidence level has been reached. For example, for an intended byte of 01010101 sent over the network medium, badly received bytes could include 01110101, 11010100, and 00001101. In this case, confidence services 212, may develop a confidence level based at least in part on the facts that three bytes were received, bit 0 was 1 in two of three bytes received, bit 1 was 0 in all three bytes received, bit 2 was 1 in all three bytes received, etc. The threshold confidence level may be adjustable, and may require at least five badly received frames, for example. Also, the threshold confidence level may require an occurrence rate (used to determine probability) of each bit value to be at least eighty percent, for example.

As an added measure of verification, confidence services 212 may compute a CRC value based on the estimate frame and compare that value to an estimate of the CRC value of the intended frame. When the threshold confidence level has been reached, confidence services 212 may provide an indication to control logic 202.

Construct services 214, as introduced above, may provide estimation agent 112 with the ability to construct and process an estimate frame. In one embodiment, after the threshold confidence level has been reached, construct services 214 is invoked to pass the estimate frame up the communication stack. In another example embodiment, construct services 214 may send an acknowledgement of receipt of the intended frame to the sender of the frame.

FIG. 3 is a flow chart of an example method for frame level recovery using a collection of badly received frames, in accordance with one example embodiment of the invention. It will be readily apparent to those of ordinary skill in the art that although the following operations may be described as a sequential process, many of the operations may in fact be performed in parallel or concurrently. In addition, the order of the operations may be re-arranged without departing from the spirit of embodiments of the invention.

According to but one example implementation, method 300 begins with store services 210 being invoked to save (302) badly received frames. In one example embodiment, badly received frames may be stored in memory 204, until the intended frame is received properly or a confident estimate is constructed and processed or after a maximum retry limit, no confident estimate frame can be constructed.

Next, estimation agent 112 may invoke confidence services 212 to develop confidence (304) in an estimate frame. In one example embodiment, confidence services 212 computes a confidence level whenever a badly received frame is added to memory 204. In another example embodiment, confidence services 212 may not begin to compute a confidence level until after a certain number of badly received frames have been collected. Steps 302 and 304 may be repeated until confidence services 212 has determined that a threshold confidence level has been reached.

Next, confidence services 212 may verify (306) the estimate frame. In one embodiment, confidence services 212 compute a CRC value for the estimate frame and compare that value to an estimate for the CRC value from within the badly received frames.

Next, control logic 202 may selectively invoke construct services 214 to send (308) an acknowledgement for the intended frame. In one example embodiment, the acknowledgement (or ACK) may improve communication performance by inhibiting the subsequent transmission of the same previously badly received frame.

Next, estimation agent 112 may pass (310) the estimate frame up the communication stack. In one embodiment, construct services 214 performs this step contemporaneous to sending the ACK.

FIG. 4 illustrates a block diagram of an example storage medium comprising content which, when accessed by a device, causes the device to implement one or more embodiment(s) of the invention, for example estimation agent 112 and/or associated method 300. In this regard, storage medium 400 includes content 402 (e.g., instructions, data, or any combination thereof) which, when executed, causes the appliance to implement one or more aspects of estimation agent 112, described above.

The machine-readable (storage) medium 400 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

Many of the methods are described in their most basic form but operations can be added to or deleted from any of the methods and information can be added or subtracted from any of the described messages without departing from the basic scope of the present invention. Any number of variations of the inventive concept is anticipated within the scope and spirit of the present invention. In this regard, the particular illustrated example embodiments are not provided to limit the invention but merely to illustrate it. Thus, the scope of the present invention is not to be determined by the specific examples provided above but only by the plain language of the following claims.

What is claimed is:

1. A method comprising:
storing contents from a plurality of badly received frames; and
using the contents to generate an estimate frame for an intended frame.

2. The method of claim 1, further comprising:
verifying the estimate frame using a cyclic redundancy code.

3. The method of claim 1, further comprising:
transmitting an acknowledgement of receipt of the intended frame.

4. The method of claim 1, further comprising:
passing the estimate frame up a communication stack.

5. The method of claim 1, wherein storing contents from a plurality of badly received frames comprises:
storing contents from a plurality of badly received wireless network frames.

6. The method of claim 1, wherein using the contents to generate an estimate frame for the intended frame comprises:
constructing an estimate frame for an intended frame after reaching a threshold confidence level based at least in part on a number of frames received and a probability for each bit field.

7. An electronic appliance, comprising:
a processor;
a memory;
a network controller; and
an estimation engine coupled with the network controller, the memory and the processor, the estimation engine to store contents from a plurality of badly received frames, and to use the contents to generate an estimate frame for an intended frame.

8. The electronic appliance of claim 7, further comprising:
the estimation engine to transmit an acknowledgement of receipt of the intended frame.

9. The electronic appliance of claim 7, further comprising:
the estimation engine to pass the estimate frame up a communication stack.

10. The electronic appliance of claim 7, wherein the estimation agent to use the contents to generate an estimate frame for an intended frame comprises:
the estimation agent to construct an estimate frame for an intended frame after reaching a threshold confidence level based at least in part on a number of frames received and a probability for each bit field.

11. A storage medium comprising content which, when executed by an accessing machine, causes the accessing machine to store contents from a plurality of badly received frames and to use the contents to generate an estimate frame for an intended frame.

12. The storage medium of claim 11, further comprising content which, when executed by the accessing machine, causes the accessing machine to transmit an acknowledgement of receipt of the intended frame.

13. The storage medium of claim 11, further comprising content which, when executed by the accessing machine, causes the accessing machine to pass the estimate frame up a communication stack.

14. The storage medium of claim 11, further comprising content which, when executed by the accessing machine, causes the accessing machine to verify the estimate frame using a cyclic redundancy code.

15. The storage medium of claim 11, wherein the content to use the contents to generate an estimate frame for an intended frame comprises content which, when executed by the accessing machine, causes the accessing machine to construct an estimate frame for an intended frame after reaching a threshold confidence level based at least in part on a number of frames received and a probability for each bit field.

16. An apparatus, comprising:
a network interface;
a bus interface; and
control logic coupled with the network and bus interfaces, the control logic to store contents from a plurality of badly received frames and to use the contents to generate an estimate frame for an intended frame.

17. The apparatus of claim 16, further comprising control logic to transmit an acknowledgement of receipt of the intended frame.

18. The apparatus of claim 16, further comprising control logic to pass the estimate frame up a communication stack.

19. The apparatus of claim 16, further comprising control logic to verify the estimate frame using a cyclic redundancy code.

20. The apparatus of claim 16, wherein the control logic to generate an estimate frame for an intended frame comprises control logic to construct an estimate frame for an intended frame after reaching a threshold confidence level based at least in part on a number of frames received and a probability for each bit field.
